(19) United States
(12) Patent Application Publication
(10) Pub. No.: US 2015/0003265 A1
(43) Pub. Date: Jan. 1, 2015

(54) A-PRIORI INFORMATION IN INDOOR POSITIONING

(71) Applicant: TEXAS INSTRUMENTS INCORPORATED, Dallas, TX (US)

(72) Inventor: Mohamed Farouk MANSOUR, Richardson, TX (US)

(21) Appl. No.: 13/932,503

(22) Filed: Jul. 1, 2013

(51) Int. Cl. H04W 4/02; H04W 24/00

(52) U.S. Cl. CPC H04W 4/028; H04W 24/00
USPC 370/252

(57) ABSTRACT

A method to improve position estimates including computing, by a wireless device, a predicted future position of the wireless device from a current location estimate, computing, by the wireless device, a priori probability associated with future position candidates based on the predicted future position, and updating, by the wireless device, the future position candidates with the associated a priori probability.

### CROSS-REFERENCE TO RELATED APPLICATION

Not applicable.

### BACKGROUND

As mobile devices proliferate, the demand for services tailored to device location also increases. Location based services depend on positioning systems to determine device location. Satellite based positioning systems, such as the global positioning system (GPS), GLONASS, and Galileo can provide high accuracy, but require a clear line of sight between the satellites and the mobile device to provide a position determination. Consequently, satellite positioning systems are largely ineffective for indoor positioning. Satellite positioning also requires specialized receivers that may increase the cost of the mobile device.

As an alternative or an augmentation to satellite based positioning, wireless local area network (WLAN) based positioning systems have been developed. WLAN based positioning systems are suitable for indoor positioning and require minimal investment because they make use of existing infrastructure. Furthermore, many mobile wireless devices include support for communication via WLAN.

WLAN based positioning systems determine mobile device position based on the established positions of WLAN access points within communication range of the device and the strength of signals exchanged between the mobile device and the access points.

### SUMMARY

A method to improve position estimates includes computing, by a wireless device, a predicted future position of the wireless device from a current location estimate, computing, by the wireless device, a priori probability associated with future position candidates based on the predicted future position, and updating, by the wireless device, the future position candidates with the associated a priori probability.

A wireless device implementing improved position estimates includes a wireless transceiver to receive wireless signals from wireless local area network access points (APs), and a positioning system coupled to the wireless transceiver. The positioning system is configured to generate a current location estimate based on the wireless signals, compute a predicted future position estimate based on the current location estimate, compute a priori probability for a grid of position candidates from the predicted future estimate, and update future position likelihood data associated with each grid position candidate with their corresponding a priori probability. A grid is just one implementation of the current disclosure and is mainly used for ease of explanation. Any other arrangement of potential position points is also included in the current disclosure.

In another embodiment, an indoor positioning system implementes improved position estimation. The system includes a Kalman filter to predict a future position estimate and a corresponding covariance based on an initial position estimate, and a position estimator coupled to the Kalman filter to generate a grid of future position candidates centered on the future position estimate and update the future position candidates with a priori probability information computed using the future position estimate and the corresponding covariance.

In yet another embodiment, a mobile wireless device includes a transceiver to receive wireless received strength of signal indicator (RSSI) signals from a plurality of Wi-Fi access points (APs) and a RSSI signal-based positioning system. The RSSI-based positioning system is configured to generate a current location estimate based on the RSSI signals, compute a future position estimate and a corresponding covariance based on the current position estimate using a Kalman filter, generate a probability density function based on the future position estimate and the corresponding covariance, compute a priori probability for a grid of position candidates based on the probability density function, and update the grid of position candidates for a future position with the a priori probability computed for each position candidate.

### BRIEF DESCRIPTION OF THE DRAWINGS

For a detailed description of exemplary embodiments of the invention, reference will now be made to the accompanying drawings in which:

FIG. 1 shows a block diagram of a system for using WLAN access points to determine the position of a wireless device in accordance with various embodiments;

FIG. 2 shows a block diagram of a mobile wireless device in accordance with various embodiments; and

FIG. 3 is a flow diagram for a method for updating position candidates of a mobile wireless device with a priori probability information in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In order for a mobile wireless device to establish its location via wireless local area network (WLAN) positioning, the device receives signals transmitted by access points (APs) in the vicinity of the device. The locations of the APs are known, and based on the strengths of the received AP signals the mobile wireless device may estimate its position. The accuracy of the estimated position of the device may be increased by using predicted future values based on the previous position estimate to update a grid of possible position candidates for the current or future position estimate. That is, the device estimates its position based on, not only the strength of the signal form nearby APs, but also based on its previously determined position.

A search algorithm may be used by the wireless devices to find the best position estimate. The search algorithm may search over a set of position candidates, or points on a grid, to find the best estimate. The estimator, however, may consider all position candidates to be equally probable, which may not be true and may reduce the accuracy of the estimator. To increase the accuracy of the position estimator, a priori probability information based on earlier positioning history may be added back into the position estimate to effect the probability associated with each position candidate.

Disclosed herein are methods and devices for WLAN indoor positioning by wireless devices. The indoor positioning may use a predicted future position based on a current position to generate a priori probabilities for a grid of potential position estimates. The wireless device may then update the current position candidates with the a priori probabilities to enhance a future position estimate.

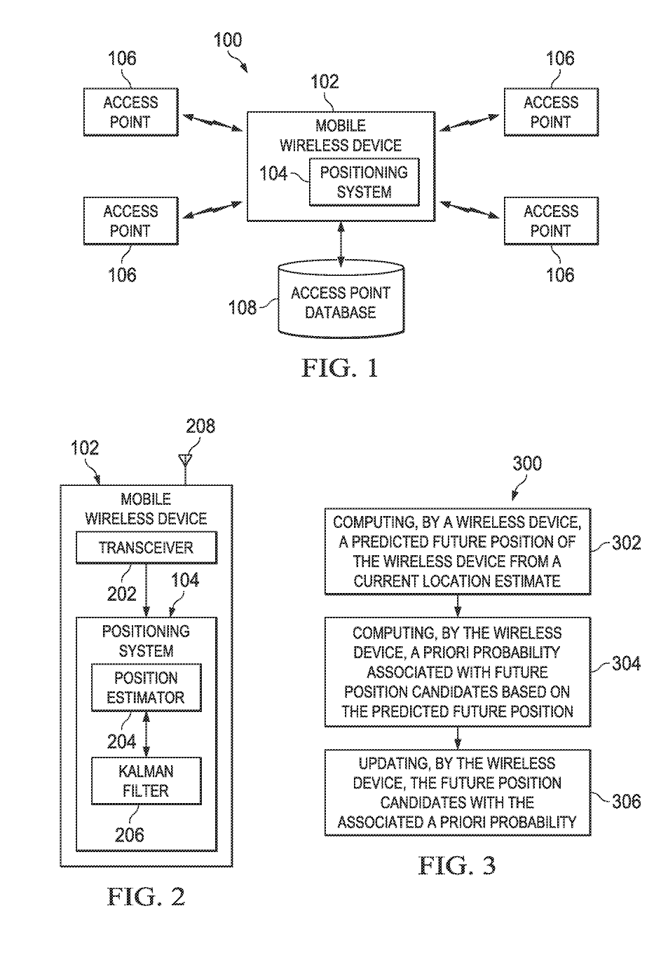

FIG. 1 shows a block diagram of a system 100 for using WLAN APs to determine the position of a wireless device in accordance with various embodiments. The system 100 includes a mobile wireless device 102 and a plurality of WLAN APs 106. The mobile wireless device 102 is positioned to wirelessly communicate with one or more of the APs 106 each associated with a WLAN (e.g., a network in accordance with one or more the IEEE 802.11 standards). In the embodiment of FIG. 1, the mobile wireless device 102 is positioned to receive transmissions from and/or communicate with any of the APs 106. The mobile wireless device 102 may be a cellular telephone, a tablet computer, or any other mobile computing device configured for WLAN access. While only four access points and a single mobile wireless device are shown in FIG. 1, in practice the system 100 may include any number of mobile wireless devices and APs.

The mobile wireless device 102 includes a WLAN positioning system 104 that determines the position of the mobile wireless device 102 based on the strengths of the signals received from the APs 106 and the known positions of the APs 106. In some embodiments of the system 100, the AP database 108 provides information regarding the positions of the APs 106 to the mobile wireless device 102. For example, the position of each AP 106 may be determined using satellite positioning (or other positioning techniques) and stored in the AP database 108 with information that identifies the AP 106. The position of each AP 106 may be given in longitude and latitude or in relation to a reference point of the surrounding structure. The AP database 112 may be contained within the mobile wireless device 102 or accessible to the mobile wireless device 102 via one of the APs 106 or via a different communication network (e.g., a wireless wide area network). Alternatively, each AP 106 may be programmed with its own position and thus the AP database 112 is essentially distributed across the APs 106.

The WLAN positioning system 104 provides improved positioning for the mobile wireless device 102 by dynamically updating a grid of position candidates with a priori probability information based on an estimate of a future position given the current position estimate. By adding the a priori probability information associated with the position candidates on the grid, the mobile wireless device 102 may improve the position estimate based on a predicted future position of the mobile wireless device 102.

FIG. 2 shows a block diagram of the mobile wireless device 102 in accordance with various embodiments described herein. The mobile wireless device 102 is configured to update a grid of possible future position estimates using a predicted future position estimate based on a prior or current position estimate. The mobile wireless device 102 includes an antenna 208, a WLAN transceiver 202 and a WLAN positioning system 104. The WLAN transceiver 202 provides an interface through which the mobile wireless device 102 accesses the wireless medium to communicate with one or more of the APs 104-110. The WLAN transceiver 202 receives signals transmitted by the APs 104-110 and derives signal strength values, such as received signal strength indicator (RSSI) values, from the received signals, that may be used to estimate distance between the mobile wireless device 102 and the APs 104-110 for WLAN-based positioning.

The WLAN positioning system 104 may be coupled to the WLAN transceiver 202. The WLAN positioning system 104 includes a position estimator 204 and a Kalman filter 206. The position estimator 204 may estimate the position of the wireless device 102 based on a known position of each AP 104-110, the received signal strength values for each AP 104-110, and the channel model for each AP 104-110. In some embodiments, the WLAN transceiver 202 provides received signal strength values to the WLAN positioning system 104, and the AP database 108 provides AP location information for use in mobile wireless device 102 position determination.

The Kalman filter 206 communicates with the position estimation module 204. The Kalman filter 206 may provide a future position estimate for the mobile device 102 based on the current position estimate, which is based on the minimum mean square error (MMSE) information computed by the position estimator 204. The MMSE information may include a rough position estimate and a corresponding covariance of that position estimate. The position estimate is termed “rough” because it is only based on the analysis of the RSSI measurements, which may result in inaccuracy due to noise or attenuation of some signals that affects the position calculation. The future position estimate may then be sent back to the position estimator 204 so that a priori probability data may be calculated for augmenting a future position estimate. Further, the Kalman filter 206 may simplify the position estimate by the position estimator 204. The Kalman filter 206 may be dedicated circuitry that communicates with the position estimator 204 and various other components of the mobile wireless device 102.

Various components of the mobile wireless device 102 including at least some portions of the WLAN positioning system 104 may be implemented using a processor executing software that causes the processor to perform the operations described herein. In some embodiments, the WLAN positioning system 104 includes a processor executing software instructions that causes the processor to dynamically calculate the future and current position estimate of the mobile device 102 as disclosed herein, and to apply the future position estimates and a priori probabilities to improve the positioning accuracy of the mobile wireless device 102.

Suitable processors include, for example, general-purpose microprocessors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming (i.e., processor executable instructions) that causes a processor to perform the operations disclosed herein can be stored in a computer readable storage medium. A computer readable storage medium comprises volatile storage such as random access memory, non-volatile storage (e.g., a hard drive, an optical storage device (e.g., CD or DVD), FLASH storage, read-only-memory), or combinations thereof. Processors execute software instructions. Software instructions alone are incapable of performing a function. Therefore, in the present disclosure any reference to a function performed by software instructions, or to software instructions performing a function is simply a shorthand means for stating that the function is performed by a processor executing the instructions.

In some embodiments, portions of the mobile wireless device 102, including portions of the WLAN positioning system 104 may be implemented using dedicated circuitry (e.g., dedicated circuitry implemented in an integrated circuit). Some embodiments may use a combination of dedicated circuitry and a processor executing suitable software. For example, some portions of the WLAN positioning system 104 may be implemented using a processor or hardware circuitry. Selection of a hardware or processor/software implementation of embodiments is a design choice based on a variety of factors, such as cost, time to implement, and the ability to incorporate changed or additional functionality in the future.

While embodiments of the mobile wireless device 102 may be applicable to any operational environment, WLAN positioning may frequently be used in an indoor environment. The position estimation in an indoor WLAN environment may use a search grid as a basis of the position estimate. The search grid may be parameterized by three parameters: the grid center, the grid size (length and width), and the spacing of adjacent grid points. The choice of the grid center may affect the MMSE performance, the initial position estimate computed by the position estimator 204. The center of the grid could be computed as the centroid of visible APs, where each AP is scaled by the number of its RSSI measurements at the current time, i.e., if there are Iₖ measurements form the k-th AP, then the center of the search grid may be computed as

(x_{c}, y_{c})=Σ_{c}Iₖ(xₖ, yₖ)/(Σ_{c}Iₖ) (Eq. 1)

where:
(x_{c}, y_{c}) is the coordinate of the centroid;
Iₖ is the RSSI measurement from the k-th AP; and
(xₖ, yₖ) is the coordinate of the k-th AP.
Yet, when the true position of the mobile device 102 is far from the center of the grid based on the location of the visible APs, as described by Eq. 1, the whole grid may also be far from the true position resulting in an estimate that may not be correct.

Alternatively or additionally, the search grid initialization may use a past predicted position estimate form the Kalman filter 206 as the centroid of the search grid. If the estimated Kalman state at time t is x(t|t), then the future estimate of the Kalman state x(t+1|t), which is computed from the basic Kalman state equation as, may be

x_{t+1|t}=φₜ₊₁x_{t|t} (Eq. 2)

where φₜ₊₁ is the state transition matrix at time t+1. The corresponding covariance matrix M(t+1|t) is computed recursively from the old covariance matrix M(t|t) as

M_{t+1|t}=φt+1M_{t|t}φₜ₊₁^{T}+Qₜ₊₁ (Eq. 3)

where Qₜ₊₁ is the Kalman model noise at time t+1. The Kalman state may have the (x, y) coordinate position of the estimated position and the velocity vector. The position part of the predicted state x_{t+1|t} may be used as the center of the search grid. The combination of Eqs. 2 and 3, in general, form a Gaussian distribution that forms the basis of a probability distribution function for determining the a priori probabilities.

Implementing the positioning algorithm assumes that all grid points on the search grid are equally probable. This assumption is made to allow proper assignment of prior knowledge about the likelihood of the individual covariance of the Kalmam filter 206. The Kalman filter 206 works from a normal distribution, the output estimate may be unbiased and may be viewed as a Gaussian random vector. A probability distribution of the estimated vector may be a multivariate Gaussian distribution. Since the true position is not known, the Kalman estimate, Eq. 2, may be used as the mean of the distribution. The center of the search grid and the corresponding covariance may then be computed using Eq. 2 and Eq. 3.

The computation of the a priori probability for the grid points assumes that the true position at time t+1 has a Gaussian distribution with mean x(t+1|t) given by Eq. 2 and a covariance Γ, which is the top-right 2×2 block of the matrix M(t+1|t) as given by Eq. 3. The probability density function (PDF) of the position (x, y) may have the general form:

$$p ( x , y ) = \frac{1}{\sqrt{2 π det ( Γ )}} exp ( {( [ x , y ] - [ {μ}_{x} , {μ}_{y} ] )}^{T} {Γ}^{- 1} ( [ x , y ] - [ {μ}_{x} , {μ}_{y} ] ) ) \qquad ( Eq . 4 )$$

where μₓ and μ_{y} are the first two states of x(t+1|t) Kalman estimate, and Γ is the top-right 2×2 block of M(t+1|t).

Thus, the generation of the a priori probability information at time t+1 may proceed by first computing x(t+1|t), M(t+1|t) as in Eqs. 2 and 3. The position component, Eq. 2, x(t+1|t), becomes the center of the grid while the other two grid parameters (area and spacing) remain the same. The search grid may then be constructed as before. For each grid point, compute the logarithm of the PDF, Eq. 4, for that position coordinate. The logarithm of the PDF for each grid point is the a priori probability information for that grid point. In the overall positioning algorithm, the likelihood of each grid point is updated by adding the a priori probability information to the common likelihood of that grid point. The resulting likelihood for each grid point may then be enhanced due to the addition of the possible future position based on the Kalman filter 206's predictive capabilities.

FIG. 3 is a flow diagram for a method 300 for updating position candidates of a mobile wireless device with a priori probability information in accordance with various embodiments. The method 300 begins at block 302 with computing, by a wireless device, a predicted future position of the wireless device from a current location estimate. The computation of the predicted future estimate may be performed by the Kalman filter 206 implementing the Kalman filter predictive capabilities represented by Eqs. 2 and 3 above.

The method 300 then continues at step 304 with computing, by the wireless device, a priori probability associated with future position candidates based on the predicted future position. The a priori probability may be calculated by the position estimator 204 by first constructing a PDF function similar to Eq. 4, calculating the PDF for each future position candidate, and then taking the logarithm of that PDF calculation.

The method 300 then ends at step 306 with updating, by the wireless device, the future position candidates with the associated a priori probability. The position estimator 204 may then add the priori probability back to the future position candidates.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method to improve position estimates, comprising:
computing, by a wireless device, a predicted future position of the wireless device from a current location estimate;
computing, by the wireless device, a priori probability associated with future position candidates based on the predicted future position; and
updating, by the wireless device, the future position candidates with the associated a priori probability.

2. The method of claim 1, further comprising:
generating, by the wireless device, a grid of the future position candidates centered on the predicted future position.

3. The method of claim 1, further comprising generating, by the wireless device, a probability density function (PDF) based on the predicted future position.

4. The method of claim 3, wherein the PDF is computed for each of the future position coordinates.

5. The method of claim 1, wherein the a priori probability is computed by calculating the logarithm of the PDF associated with each of the future position candidates.

6. The method of claim 1, wherein the predicted future position includes a grid coordinate and a corresponding covariance.

7. A wireless device, comprising:
a wireless transceiver to receive wireless signals from wireless local area network access points (APs); and
a positioning system coupled to the wireless transceiver to:
generate a current location estimate based on the wireless signals;
compute a predicted future position estimate based on the current location estimate;
compute a priori probability for a grid of position candidates from the predicted future estimate; and
update future position likelihood data associated with each grid position candidate with their corresponding a priori probability.

8. The device of claim 7, further comprising a Kalman filter to generate the future position estimate.

9. The device of claim 7, further comprising a position estimator to generate the current location estimate and to update the future position likelihood data with the a priori probability for each grid position.

10. The device of claim 7, The device of claim 7, wherein the coordinate of the future position estimate is used as a center of the grid of position candidates.

11. The device of claim 7, wherein the predicted future position estimate includes a coordinate and a corresponding covariance.

12. The device of claim 7, wherein the position likelihood data includes a coordinate and a corresponding covariance.

13. The device of claim 7, wherein the position likelihood data and the future position likelihood data includes velocity information.

14. An indoor positioning system, comprising:
a Kalman filter to predict a future position estimate and a corresponding covariance based on an initial position estimate; and
a position estimator coupled to the Kalman filter to generate a grid of future position candidates centered on the future position estimate and update the future position candidates with a priori probability information computed using the future position estimate and the corresponding covariance.

15. The system of claim 14, wherein the position estimator is to generate the initial position estimate for a wireless device based on signals received from wireless network access points.

16. The system of claim 14, wherein the position estimator is to generate a probability density function (PDF) that includes the future position estimate and the corresponding covariance.

17. The system of claim 14, wherein the position estimator computes the a priori probability for each future position candidate by inserting the coordinates for each future position candidate into the PDF then calculating the logarithm of the resulting value.

18. The system of claim 14, wherein the initial and future position estimates also include velocity information.

19. A mobile wireless device, comprising:
a transceiver to receive wireless received strength of signal indicator (RSSI) signals from a plurality of Wi-Fi access points (APs); and
a RSSI signal-based positioning system to:
generate a current location estimate based on the RSSI signals;
compute a future position estimate and a corresponding covariance based on the current position estimate using a Kalman filter;
generate a probability density function based on the future position estimate and the corresponding covariance; and
compute a priori probability for a grid of position candidates based on the probability density function; and
update the grid of position candidates for a future position with the a priori probability computed for each position candidate.
